(19) United States
(12) Patent Application Publication
(10) Pub. No.: US 2019/0011733 A1
(43) Pub. Date: Jan. 10, 2019

(54) INSPECTION METHOD AND INSPECTION APPARATUS FOR DISPLAY PANEL

(71) Applicants: HKC Corporation Limited, Shenzhen (CN); Chongqing HKC Optoelectronics Technology Co.,Ltd., Chongqing, (CN)

(72) Inventor: CHUNG-KUANG CHIEN, (US)

(21) Appl. No.: 15/744,793

(22) PCT Filed: May 26, 2017
(86) PCT No.: PCT/CN2017/086139

§ 371 Date: Jan. 13, 2018

(30) Foreign Application Priority Data
Mar. 24, 2017 (CN) 2017101822454

(51) Int. Cl. G02F 1/13; G02B 21/36; G06T 7/00; G02B 21/00

(52) U.S. Cl. CPC G02F 1/1309; G02B 21/368; G02B 21/0036; G02B 21/365; G06T 7/0002

(57) ABSTRACT

The present application discloses an inspection method and an inspection apparatus for a display panel. The inspection method includes the following steps: acquiring original images by continually scanning the display panel by shooting the display panel, preprocessing the acquired original images to obtain an image to be inspected, and inspecting the image to be inspected and outputting a result.

### TECHNICAL FIELD

The present application relates to the technical field of displays, more particularly to an inspection method and an inspection apparatus for a display panel.

### BACKGROUND

Liquid crystal display apparatuses have numerous advantages, such as a thin body, power saving, no radiation, etc., and are widely used. Most liquid crystal display apparatuses in the current market are backlit type liquid crystal display apparatuses, each including a liquid crystal panel and a backlit module. Working principle of the liquid crystal panel is that liquid crystals are put in two parallel glass substrates, and a driving voltage is applied to two glass substrates to control rotation of the liquid crystals, to refract light rays of the backlit module to generate a picture.

Thin film transistor-liquid crystal display apparatuses (TFT-LCD apparatuses) currently maintain a leading status in the display field because of low power consumption, excellent picture quality, high production yield, and other properties. Similarly, the TFT-LCD apparatus comprises a liquid crystal panel and a backlit module. The liquid crystal panel comprises a color filter substrate (CF substrate) and a thin film transistor substrate (TFT substrate), and transparent electrodes on relative inner sides of the above substrates. A layer of liquid crystals (LCs) is positioned between two substrates.

However, mura develops when brightness of a display apparatus is uneven. This causes various traces to affect display of the display panel and visual experience of users. When brightness of the display panel is abnormal in a wide area, a lot of time will be spent in shooting and measuring, and manual focusing often generates errors that are not easy to be found and overcome, especially for an abnormal brightness region having minimal changes.

### SUMMARY

A technical problem to be solved by the present application is to provide a convenient and accurate inspection method for a display panel.

In addition, the present application also provides a display apparatus for the display panel.

Purposes of the present application are achieved by the following technical solution.

The inspection method for the display panel, comprising:

acquiring original images by continually scanning the display panel by shooting the display panel,

preprocessing the acquired original images to obtain an image to be inspected, and

inspecting the image to be inspected and outputting a result.

The step of acquiring original images by continually scanning the display panel by shooting the display panel comprises a step of transmitting the original images acquired within a preset range to a preprocessing step of the inspection method.

The step of preprocessing the acquired original images to obtain the image to be inspected comprises a step of cutting and splicing the original images according to a preset size to obtain the image to be inspected. A form that the images are acquired and processed simultaneously, or the images are acquired first and then are processed together may exist by setting different preset ranges, for example, by taking time, number of ordinary shots, the display panel within a certain range and the like as measures.

According to another aspect of the present application, the present application further discloses an inspection apparatus for the display panel, comprising:

an image acquisition unit configured to acquire original images by continually scanning the display panel by shooting the display panel,

an image preprocessing unit configured to preprocess the original images to obtain an image to be inspected, and

an image inspection unit configured to inspect the image to be inspected and output a result.

The inspection apparatus comprises a movable portion including a first moving direction and a second moving direction perpendicular to the first moving direction. When the movable portion moves from the first moving direction to the second moving direction, or when the movable portion moves from the second moving direction to the first moving direction, the image preprocessing unit splices the original images acquired by the image acquisition unit under movement of the movable portion. The moving direction of the movable portion should be defined and presented in a manner of splicing the images to facilitate observation.

When the movable portion moves along the first moving direction, the original images, acquired by the image acquisition unit, are disposed along the first moving direction; and when the movable portion moves from the first moving direction to the second moving direction, the original images, acquired by the image acquisition unit, are reversely disposed along the first moving direction; and the image preprocessing unit splices the original images acquired by the image acquisition unit under the movement of the movable portion along the second moving direction.

Alternatively, when the movable portion moves along the second moving direction, the original images, acquired by the image acquisition unit, are disposed along the second moving direction; and when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion along the first moving direction. The above are specific splicing manners.

The image acquisition unit comprises an optical microscope. A charge coupled device (CCD) camera is disposed on the optical microscope. The movable portion is the CCD. The CCD comprises a CCD chip. The image of a shot object is focused onto the CCD chip. The CCD accumulates a corresponding proportion of electrical charges according to the strength of light. The electrical charges accumulated by each pixel are moved point by point under the control of video timing, and are filtered and amplified to form video signal output.

The image acquisition unit comprises the optical microscope. The CCD is disposed on the optical microscope. The movable portion is a load-bearing platform of the optical microscope.

A shockproof mechanism is disposed on the load-bearing platform of the optical microscope. When the load-bearing platform is used as the movable portion, the shockproof mechanism can ensure stability of the inspection apparatus to improve quality of the shot images.

The image inspection unit inspects the image to be inspected along a preset direction. The image inspection unit inspects a brightness value of the image to be inspected. A certain direction makes the inspection more orderly, avoids missing regions and ensures normal and comprehensive inspection of the inspection apparatus for the display panel.

The image inspection unit comprises an abnormal display region warning portion of the display panel. When the image inspection unit inspects that the brightness value of the image to be inspected enters a brightness value threshold of an abnormal display region, the abnormal display region warning portion outputs a result of issuing warning to the inspection apparatus, thereby finding and overcoming an abnormal brightness region with minimal changes for an OK-NG-OK region.

In the present application, the display panel is shot in a panoramic scanning manner while abnormal regions are automatically inspected, thereby reducing measurement time of the abnormal regions, satisfying needs of inspection of the abnormal regions in a wide range, achieving accurate measurement and use convenience, and improving the display style of the display panel and visual experience of users.

### BRIEF DESCRIPTION OF THE DRAWINGS

The drawings included are used for providing further understanding of embodiments of the present application, constitute part of the description, and are used for illustrating implementation manners of the present application, and interpreting principles of the present application together with text description. Apparently, the drawings in the following description are merely some embodiments of the present application, and for those of ordinary skill in the art, other drawings can also be obtained according to the drawings without contributing creative labor. In the drawings:

FIG. 1 is a flowchart of an inspection method for a display panel according to an embodiment of the present application.

FIG. 2 is a functional block diagram of an inspection apparatus for a display panel according to an embodiment of the present application.

FIG. 3 is a functional block diagram of an inspection apparatus for a display panel according to an embodiment of the present application.

FIG. 4 is a structural schematic diagram of an inspection apparatus for a display panel according to an embodiment of the present application.

FIG. 5 is a schematic diagram of inspection of a display panel according to an embodiment of the present application.

FIG. 6 is a schematic diagram of inspection of a display panel according to an embodiment of the present application.

FIG. 7 is a schematic diagram of image shooting of an inspection apparatus for a display panel according to an embodiment of the present application.

FIG. 8 is a schematic diagram of image shooting of an inspection apparatus for a display panel according to an embodiment of the present application.

### DETAILED DESCRIPTION OF INVENTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited by “first” and “second” can explicitly or impliedly include one or more features. In the description of the present application, the meaning of “a plurality of” is two or more unless otherwise specified. In addition, the term “comprise” and any variant are intended to cover non-exclusive inclusion.

It should be noted in the description of the present application that, unless otherwise specifically regulated and defined, terms such as “installation,” “bonded,” and “bonding” shall be understood in broad sense, and for example, may refer to fixed bonding or detachable bonding or integral bonding, may refer to mechanical bonding or electrical bonding, and may refer to direct bonding or indirect bonding through an intermediate medium or inner communication of two elements. For those of ordinary skill in the art, the meanings of the above terms in the present application may be understood according to concrete conditions.

The terms used herein are intended to merely describe concrete embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

The present application will be further described in detail below in combination with the drawings and preferred embodiments.

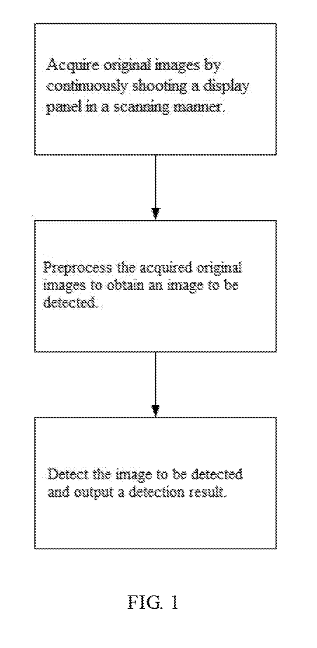

The flowchart of an inspection method for a display panel according to an embodiment of the present application is described below by reference to FIG. 1. As an embodiment of the present application, as shown in FIG. 1, the inspection method for the display panel comprises:

acquiring original images by continually scanning the display panel by shooting the display panel 4,

preprocessing the acquired original images to obtain an image to be inspected, and

inspecting the image to be inspected and outputting a result.

The display panel is shot in a panoramic scanning manner while abnormal regions are automatically inspected, thereby reducing measurement time of the abnormal regions, satisfying inspection needs of the abnormal regions across broad sections, achieving accurate measurement and convenience, and improving display of the display panel and visual experience of users. During image acquisition, a signal-to-noise ratio of the image can be increased by a long exposure time or a multi-image averaging method. Adverse effects during image acquisition can be reduced by smoothing operations, filtering, and other processing manners in preprocessing.

In another embodiment of the present application, the inspection method for the display panel comprises:

acquiring original images by continually scanning the display panel by shooting the display panel,

preprocessing the acquired original images to obtain an image to be inspected, and

inspecting the image to be inspected and outputting a result.

The step of acquiring original images by scanning the display panel by continually shooting the display panel comprises a step of transmitting the original images acquired within a preset range to a preprocessing step of the inspection method. The step of preprocessing the acquired original images to obtain the image to be inspected comprises a step of cutting and splicing the original images according to a preset size to obtain the image to be inspected.

The display panel is shot in a panoramic scanning manner while abnormal regions are automatically inspected, thereby reducing measurement time of the abnormal regions, satisfying inspection needs of the abnormal regions in a wide range, achieving accurate measurement and convenience, and improving the display of the display panel and visual experience of users. The original images acquired within the preset range are transmitted to the preprocessing step of the inspection method. The images are either acquired and processed simultaneously, or the images are acquired first and then are processed together. This can be done by setting different preset ranges, for example, by taking time, number of ordinary shots, or using display panels only within a certain range and the like as measures.

Specifically, before the step of acquiring original images by continually scanning the display panel by on the display panel, the inspection method can comprise the following steps: observing abnormal display of the display panel in a lit state, splitting and parsing the display panel to confirm that the display is abnormal, observing an abnormal display region5 to find panel defects, and removing an alignment film.

In another embodiment of the present application, as shown in FIG. 2, the inspection apparatus for the display panel comprises:

an image acquisition unit configured to acquire original images by continually scanning the display panel by shooting the display panel,

an image preprocessing unit configured to preprocess the acquired original images to obtain an image to be inspected, and

an image inspection unit configured to inspect the image to be inspected and output a result.

The display panel is shot by the image acquisition unit in a panoramic scanning manner. The image inspection unit automatically inspects to obtain the abnormal regions after the image preprocessing unit pre-processes the shot images, thereby reducing measurement time of the abnormal regions, satisfying inspection needs of the abnormal regions in a wide range, achieving accurate measurement and use convenience, and improving display style of the display panel and visual experience of users.

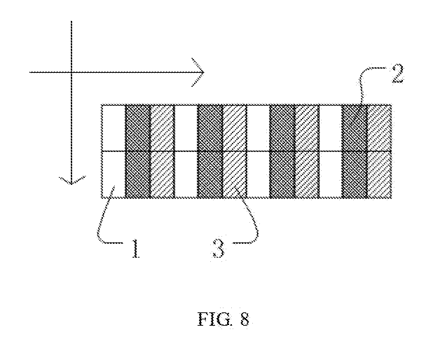

In another embodiment of the present application, as shown in FIG. 7 and FIG. 8, the inspection apparatus for the display panel comprises: an image acquisition unit configured to acquire original images by continually scanning the display panel by shooting the display panel, an image preprocessing unit configured to preprocess the acquired original images to obtain an image to be inspected, and

an image inspection unit configured to inspect the image to be inspected and output a result. The inspection apparatus comprises a movable portion including a first moving direction and a second moving direction perpendicular to the first moving direction. When the movable portion moves from the first moving direction to the second moving direction, or when the movable portion moves from the second moving direction to the first moving direction, the image preprocessing unit splices the original images acquired by the image acquisition unit under movement of the movable portion. The above are presented in a manner of splicing images to facilitate observation. When the movable portion moves along the first moving direction, the original images, acquired by the image acquisition unit, are disposed along the first moving direction; and when the movable portion moves from the first moving direction to the second moving direction, the original images, acquired by the image acquisition unit, are reversely disposed along the first moving direction; and the image preprocessing unit splices the original images acquired by the image acquisition unit under the movement of the movable portion in the second moving direction. Alternatively, when the movable portion moves along the second moving direction, the original images, acquired by the image acquisition unit, are disposed along the second moving direction; and when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion in the first moving direction. The display panel is shot by the image acquisition unit in a panoramic scanning manner. The image inspection unit automatically inspects to obtain the abnormal regions after the image preprocessing unit pre-processes the shot images, thereby reducing measurement time of the abnormal regions, satisfying inspection needs of the abnormal regions in a wide range, achieving accurate measurement and convenience, and improving display style of the display panel and visual experience of users.

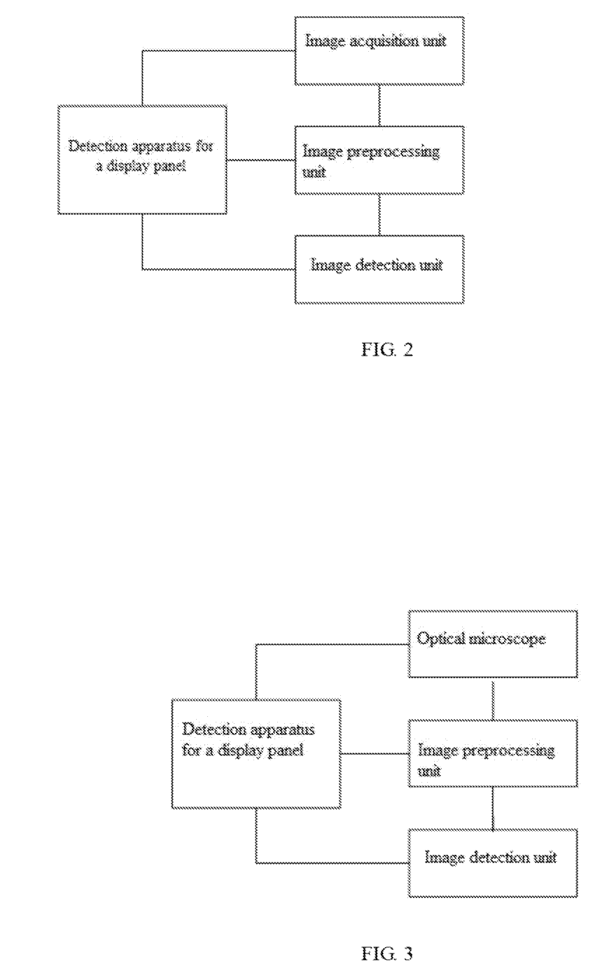

In another embodiment of the present application, as shown in FIG. 3 and FIG. 4, the inspection apparatus for the display panel comprises: an image acquisition unit configured to acquire original images by continually scanning the display panel by shooting the display panel, an image preprocessing unit configured to preprocess the acquired original images to obtain an image to be inspected, and an image inspection unit configured to inspect the image to be inspected and output a result. The image acquisition unit comprises an optical microscope. A CCD is disposed on the optical microscope. The movable portion is the CCD. The display panel is shot by the image acquisition unit in a panoramic scanning manner. The image inspection unit automatically inspects to obtain the abnormal regions after the image preprocessing unit preprocesses the shot images, thereby reducing measurement time of the abnormal regions, satisfying needs of inspection of the abnormal regions in a wide range, achieving accurate measurement and use convenience, and improving the display style of the display panel and visual experience of users. The CCD comprises a CCD chip. The image of a shot object is focused onto the CCD chip. The CCD accumulates a corresponding proportion of electrical charges according to the strength of light. The electrical charges accumulated by each pixel are moved point by point under the control of video timing, and are filtered and amplified to form a video signal output. The use of scanning and shooting requires a higher CCD resolution. During image acquisition, a signal-to-noise ratio of the image can be increased by a long exposure time or a multi-image averaging method. Adverse effects during image acquisition can be reduced by smoothing operations, filtering and other processing manners adopted by the image preprocessing unit.

The inspection apparatus comprises a movable portion. The CCD comprises a first moving direction and a second moving direction perpendicular to the first moving direction. When the CCD moves from the first moving direction to the second moving direction, or when the CCD moves from the second moving direction to the first moving direction, the image preprocessing unit splices the original images acquired by the optical microscope under the movement of the CCD. The above are represent in a manner of splicing images to facilitate observation. When the CCD moves along the first moving direction, the original images, acquired by the optical microscope, are disposed along the first moving direction; and when the CCD moves from the first moving direction to the second moving direction, the original images, acquired by the optical microscope, are reversely disposed along the first moving direction; and the image preprocessing unit splices the original images acquired by the optical microscope under the movement of the CCD in the second moving direction. Alternatively, when the CCD moves along the second moving direction, the original images, acquired by the optical microscope, are disposed along the second moving direction; and when the CCD moves from the second moving direction to the first moving direction, the original images, acquired by the optical microscope, are reversely disposed along the second moving direction; and the image preprocessing unit splices the original images acquired by the optical microscope under the movement of the CCD in the first moving direction.

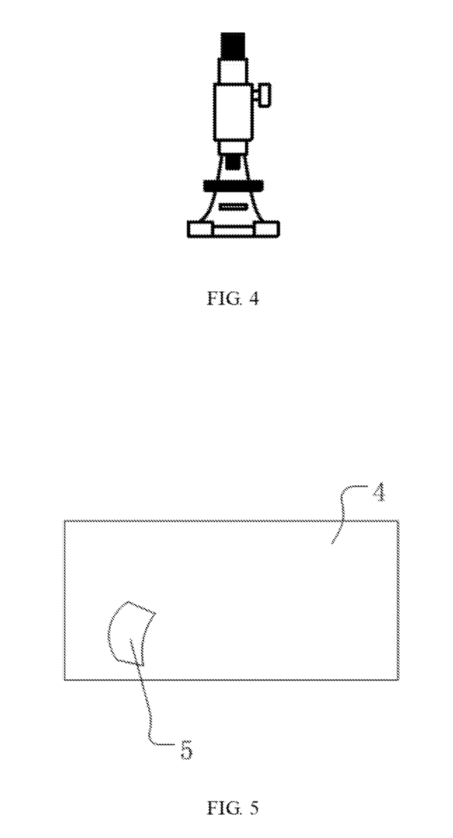

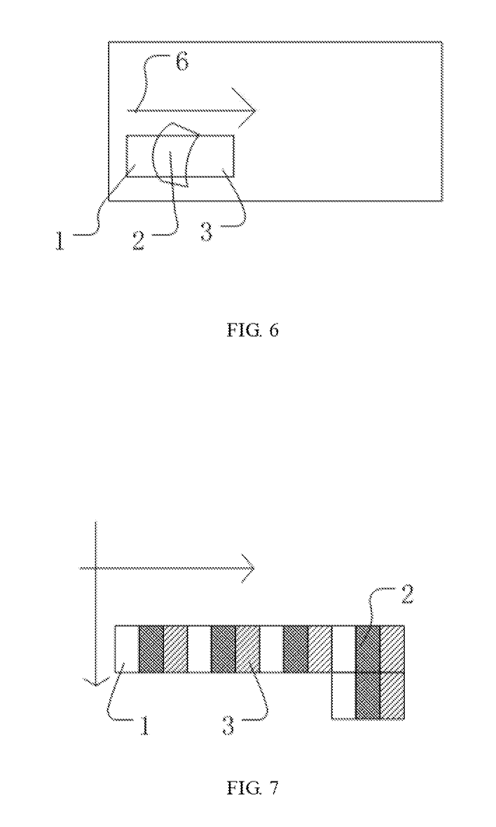

Specifically, the image inspection unit inspects the image to be inspected in a preset direction. The image inspection unit inspects a brightness value of the image to be inspected. A certain direction makes the inspection more orderly, avoids missing regions and ensures normal and comprehensive inspection of the inspection apparatus for the display panel. The image inspection unit comprises an abnormal display region warning portion of the display panel. When the image inspection unit inspects that the brightness value of the image to be inspected enters a brightness value threshold of an abnormal display region, the abnormal display region warning portion issues a warning to the inspection apparatus, thereby finding and overcoming an abnormal brightness region with minimal changes for an OK-NG-OK region (e.g., a first OK region1-an NG region2-a second OK region3 shown in figures). As shown in FIG. 4 and FIG. 5, the image inspection unit inspects the preprocessed image in a horizontal direction through the first OK region1-the NG region2-the second OK region3. When the brightness value (unit of the brightness value: CD, candela) in the NG region2 enters the brightness value threshold of the abnormal display region and after finding the abnormal display region, the abnormal display warning portion issues the warning to the inspection apparatus, for processing so that the display panel is improved to satisfy normal display. Certainly, the inspection for the image includes, but is not limited to, the brightness value as the reference. In FIG. 6, 6 refers to the inspection direction.

In another embodiment of the present application, as shown in FIG. 3 and FIG. 4, the inspection apparatus for the display panel comprises: an image acquisition unit configured to acquire original images by continually scanning the display panel by shooting the display panel, an image preprocessing unit configured to preprocess the acquired original images to obtain an image to be inspected, and an image inspection unit configured to inspect the image to be inspected and output a result. The image acquisition unit comprises an optical microscope. A CCD is disposed on the optical microscope. The movable portion is a load-bearing platform of the optical microscope. The display panel is shot by the image acquisition unit in a panoramic scanning manner. The image inspection unit automatically inspects to obtain the abnormal regions after the image preprocessing unit preprocesses the shot images, thereby reducing abnormal measurement time, satisfying needs of inspection of the abnormal regions in a wide range, achieving accurate measurement and use convenience, and improving display style of the display panel and visual experience of users. The CCD comprises a CCD chip. The image of a shot object is focused onto the CCD chip. The CCD accumulates a corresponding proportion of electrical charges according to the strength of light. The electrical charges accumulated by each pixel are moved point by point under the control of video timing, and are filtered and amplified to form video signal output. The adoption of a scanning shooting form requires higher resolution of the CCD.

The inspection apparatus comprises a movable portion. The load-bearing platform comprises a first moving direction and a second moving direction perpendicular to the first moving direction. When the load-bearing platform moves from the first moving direction to the second moving direction, or when the load-bearing platform moves from the second moving direction to the first moving direction, the image preprocessing unit splices the original images acquired by the optical microscope under the movement of the load-bearing platform. The above are presented in a manner of splicing images to facilitate observation. When the load-bearing platform moves along the first moving direction, the original images, acquired by the optical microscope, are disposed along the first moving direction; and when the load-bearing platform moves from the first moving direction to the second moving direction, the original images, acquired by the optical microscope, are reversely disposed along the first moving direction; and the image preprocessing unit splices the original images acquired by the optical microscope under the movement of the load-bearing platform in the second moving direction. Alternatively, when the load-bearing platform moves along the second moving direction, the original images, acquired by the optical microscope, are disposed along the second moving direction; and when the load-bearing platform moves from the second moving direction to the first moving direction, the original images, acquired by the optical microscope, are reversely disposed along the second moving direction; and the image preprocessing unit splices the original images acquired by the optical microscope under the movement of the load-bearing platform along the first moving direction.

As shown in FIG. 7 and FIG. 8, the load-bearing platform comprises a first moving direction (a horizontal direction) and a second moving direction (a vertical direction) perpendicular to the first moving direction. When the load-bearing platform moves from the horizontal direction to the vertical direction, the image preprocessing unit splices the original images acquired by the optical microscope under the movement of the load-bearing platform. The above are presented in a manner of splicing images to facilitate observation. When the load-bearing platform moves along the horizontal direction, the original images, acquired by the optical microscope, are disposed from left to right along the horizontal direction; and when the load-bearing platform moves from the horizontal direction to the vertical direction, the original images, acquired by the optical microscope, are reversely (from right to left) disposed along the horizontal direction; and the image preprocessing unit splices the original images acquired by the optical microscope under the movement of the load-bearing platform along the vertical direction. At this time, a camera is not moved and the load-bearing platform moves. In this way, the display panel shot in a scanning manner has a larger area and is more convenient. After the moving direction of the load-bearing platform is switched, an arrangement of a range of the acquired images of the display panel can be saved after the images are pre-processed, which also helps inspection of the images.

A shockproof mechanism is disposed on the load-bearing platform of the optical microscope. When the load-bearing platform is used as the movable portion, the shockproof mechanism can ensure stability of the inspection apparatus to improve quality of the shot images.

Specifically, the image inspection unit inspects the image to be inspected in a preset direction. The image inspection unit inspects a brightness value of the image to be inspected. A certain direction makes the inspection more orderly, avoids missing regions and ensures normal and comprehensive inspection of the inspection apparatus for the display panel. The image inspection unit comprises an abnormal display region warning portion of the display panel. When the image inspection unit inspects that the brightness value of the image to be inspected enters a brightness value threshold of an abnormal display region, the abnormal display region warning portion issues warning to the inspection apparatus, thereby finding and overcoming an abnormal brightness region with minimal changes for an OK-NG-OK region (e.g., a first OK region1-an NG region2-a second OK region3 shown in figures). As shown in FIG. 4 and FIG. 5, the image inspection unit inspects the preprocessed image in the horizontal direction through the first OK region1-the NG region2-the second OK region3. When the brightness value (unit of the brightness value: CD, candela) in the NG region2 enters the brightness value threshold of the abnormal display region, the abnormal display warning portion issues the warning to the inspection apparatus, for processing after finding so that the display panel is improved to satisfy a normal display function. Certainly, the inspection for the image includes, but is not limited to, the brightness value as the reference. In FIG. 6, 6 refers to the inspection direction.

It should be noted that, in the above embodiments, the substrate may be made of glass, plastics or the like.

In the above embodiments, the display panel comprises a liquid crystal panel, an OLED (organic light-emitting diode) panel, a curved panel, a plasma panel and the like. The liquid crystal panel, taken as an example, comprises a thin film transistor substrate (TFT substrate) and a color filter substrate (CF substrate). The TFT substrate is disposed opposite to the CF substrate. A liquid crystal and a photo spacer (PS) are disposed between the TFT substrate and the CF substrate. An active switch is disposed on the TFT substrate. The active switch may be a thin film transistor (TFT). A color filter layer is disposed on the CF substrate.

In the above embodiments, the color film substrate may comprise a TFT array. A color film and the TFT array may be formed on the same substrate. The array substrate may comprise the color filter layer.

In the above embodiments, the display panel of the present application may be a curved panel.

The above contents are further detailed descriptions of the present application in combination with specific preferred embodiments. However, the concrete implementation of the present application shall not be considered to be only limited to these descriptions. For those ordinary skilled in the art to which the present application belongs, several simple deductions or replacements may be made without departing from the conception of the present application, all of which shall be considered to belong to the protection scope of the present application.

1. An inspection apparatus for a display panel, comprising:
an image acquisition unit configured to acquire original images by continually scanning the display panel by shooting the display panel;
an image preprocessing unit configured to preprocess the original images to obtain an image to be inspected; and
an image inspection unit configured to inspect the image to be inspected and output a result;
wherein the inspection apparatus comprises a movable portion including a first moving direction and a second moving direction perpendicular to the first moving direction; and when the movable portion moves from the first moving direction to the second moving direction, or when the movable portion moves from the second moving direction to the first moving direction, the image preprocessing unit splices the original images acquired by the image acquisition unit under movement of the movable portion;
when the movable portion moves along the first moving direction, the original images, acquired by the image acquisition unit, are disposed along the first moving direction; and when the movable portion moves from the first moving direction to the second moving direction, the original images, acquired by the image acquisition unit, are reversely disposed along the first moving direction; and the image preprocessing unit splices the original images acquired by the image acquisition unit under the movement of the movable portion in the second moving direction; alternatively, when the movable portion moves along the second moving direction, the original images, acquired by the image acquisition unit, are disposed along the second moving direction; when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion in the first moving direction;
wherein the image acquisition unit comprises an optical microscope, a charge coupled device (CCD) is disposed on the optical microscope, and the movable portion is the charge coupled device; alternatively, the image acquisition unit comprises the optical microscope, wherein the charge coupled device is disposed on the optical microscope, the movable portion is a load-bearing platform of the optical microscope, and a shockproof mechanism is disposed on the load-bearing platform of the optical microscope; and
wherein the image inspection unit inspects the image to be inspected along a preset direction and inspects a brightness value of the image to be inspected; and the image inspection unit comprises an abnormal display region warning portion of the display panel; and when the image inspection unit inspects the brightness value of the image to be inspected enters a brightness value threshold of an abnormal display region, the abnormal display region warning portion outputs a result of issuing warning to the inspection apparatus.

2. An inspection apparatus for a display panel, comprising:
an image acquisition unit configured to acquire original images by continually scanning the display panel by shooting the display panel;
an image preprocessing unit configured to preprocess the original images to obtain an image to be inspected; and
an image inspection unit configured to inspect the image to be inspected and output a result.

3. The inspection apparatus for the display panel according to claim 2, wherein the inspection apparatus comprises a movable portion including a first moving direction and a second moving direction perpendicular to the first moving direction; when the movable portion moves from the first moving direction to the second moving direction, or when the movable portion moves from the second moving direction to the first moving direction, the image preprocessing unit splices the original images acquired by the image acquisition unit under movement of the movable portion.

4. The inspection apparatus for the display panel according to claim 3, wherein when the movable portion moves along the first moving direction, the original images, acquired by the image acquisition unit, are disposed along the first moving direction;
when the movable portion moves from the first moving direction to the second moving direction, the original images, acquired by the image acquisition unit, are reversely disposed along the first moving direction; and the image preprocessing unit splices the original images acquired by the image acquisition unit under the movement of the movable portion in the second moving direction; alternatively, when the movable portion moves along the second moving direction, the original images, acquired by the image acquisition unit, are disposed along the second moving direction; and when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion in the first moving direction.

5. The inspection apparatus for the display panel according to claim 2, wherein the inspection apparatus comprises a movable portion including the first moving direction and the second moving direction perpendicular to the first moving direction;
when the movable portion moves from the first moving direction to the second moving direction, or when the movable portion moves from the second moving direction to the first moving direction, the image preprocessing unit splices the original images acquired by the image acquisition unit under movement of the movable portion;
when the movable portion moves along the first moving direction, the original images, acquired by the image acquisition unit, are disposed along the first moving direction; and when the movable portion moves from the first moving direction to the second moving direction, the original images, acquired by the image acquisition unit, are reversely disposed along the first moving direction; and the image preprocessing unit splices the original images acquired by the image acquisition unit under the movement of the movable portion in the second moving direction; alternatively, when the movable portion moves along the second moving direction, the original images acquired, by the image acquisition unit, are disposed along the second moving direction; and when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion in the first moving direction.

6. The inspection apparatus for the display panel according to claim 3, wherein the image acquisition unit comprises an optical microscope, a charge coupled device is disposed on the optical microscope, and the movable portion is the charge coupled device.

7. The inspection apparatus for the display panel according to claim 2, wherein the inspection apparatus comprises a movable portion including the first moving direction and the second moving direction perpendicular to the first moving direction; when the movable portion moves from the first moving direction to the second moving direction, or when the movable portion moves from the second moving direction to the first moving direction, the image preprocessing unit splices the original images acquired by the image acquisition unit under movement of the movable portion;
wherein the image acquisition unit comprises an optical microscope, a charge coupled device is disposed on the optical microscope, and the movable portion is the charge coupled device.

8. The inspection apparatus for the display panel according to claim 2, wherein the inspection apparatus comprises a movable portion including the first moving direction and the second moving direction perpendicular to the first moving direction;
when the movable portion moves from the first moving direction to the second moving direction, or when the movable portion moves from the second moving direction to the first moving direction, the image preprocessing unit splices the original images acquired by the image acquisition unit under movement of the movable portion;
when the movable portion moves along the first moving direction, the original images, acquired by the image acquisition unit, are disposed along the first moving direction; and when the movable portion moves from the first moving direction to the second moving direction, the original images, acquired by the image acquisition unit, are reversely disposed along the first moving direction; and the image preprocessing unit splices the original images acquired by the image acquisition unit under the movement of the movable portion in the second moving direction; alternatively, when the movable portion moves along the second moving direction, the original images, acquired by the image acquisition unit, are disposed along the second moving direction; and when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion along the first moving direction;
wherein the image acquisition unit comprises an optical microscope, a charge coupled device is disposed on the optical microscope, and the movable portion is the charge coupled device.

9. The inspection apparatus for the display panel according to claim 3, wherein the image acquisition unit comprises an optical microscope, a charge coupled device is disposed on the optical microscope, and the movable portion is a load-bearing platform of the optical microscope.

10. The inspection apparatus for the display panel according to claim 2, wherein the inspection apparatus comprises a movable portion including the first moving direction and the second moving direction perpendicular to the first moving direction; when the movable portion moves from the first moving direction to the second moving direction, or when the movable portion moves from the second moving direction to the first moving direction, the image preprocessing unit splices the original images acquired by the image acquisition unit under movement of the movable portion;
wherein the image acquisition unit comprises an optical microscope, a charge coupled device is disposed on the optical microscope, and the movable portion is the load-bearing platform of the optical microscope.

11. The inspection apparatus for the display panel according to claim 2, wherein the inspection apparatus comprises a movable portion including the first moving direction and the second moving direction perpendicular to the first moving direction;
when the movable portion moves from the first moving direction to the second moving direction, or when the movable portion moves from the second moving direction to the first moving direction, the image preprocessing unit splices the original images acquired by the image acquisition unit under movement of the movable portion;
when the movable portion moves along the first moving direction, the original images, acquired by the image acquisition unit, are disposed along the first moving direction; and when the movable portion moves from the first moving direction to the second moving direction, the original images, acquired by the image acquisition unit, are reversely disposed along the first moving direction; the image preprocessing unit splices the original images acquired by the image acquisition unit under the movement of the movable portion along the second moving direction; alternatively, when the movable portion moves along the second moving direction, the original images, acquired by the image acquisition unit, are disposed along the second moving direction; and when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion along the first moving direction;
wherein the image acquisition unit comprises an optical microscope, a charge coupled device is disposed on the optical microscope, and the movable portion is the load-bearing platform of the optical microscope.

12. The inspection apparatus for the display panel according to claim 9, wherein a shockproof mechanism is disposed on the load-bearing platform of the optical microscope.

13. The inspection apparatus for the display panel according to claim 2, wherein the inspection apparatus comprises a movable portion including the first moving direction and the second moving direction perpendicular to the first moving direction; when the movable portion moves from the first moving direction to the second moving direction, or when the movable portion moves from the second moving direction to the first moving direction, the image preprocessing unit splices the original images acquired by the image acquisition unit under movement of the movable portion;
wherein the image acquisition unit comprises an optical microscope, a charge coupled device is disposed on the optical microscope, the movable portion is the load-bearing platform of the optical microscope, and a shockproof mechanism is disposed on the load-bearing platform of the optical microscope.

14. The inspection apparatus for the display panel according to claim 2, wherein the inspection apparatus comprises a movable portion including the first moving direction and the second moving direction perpendicular to the first moving direction;
when the movable portion moves from the first moving direction to the second moving direction, or when the movable portion moves from the second moving direction to the first moving direction, the image preprocessing unit splices the original images acquired by the image acquisition unit under movement of the movable portion;
when the movable portion moves along the first moving direction, the original images, acquired by the image acquisition unit, are disposed in the first moving direction; and when the movable portion moves from the first moving direction to the second moving direction, the original images, acquired by the image acquisition unit, are reversely disposed along the first moving direction; and the image preprocessing unit splices the original images acquired by the image acquisition unit under the movement of the movable portion in the second moving direction; alternatively, when the movable portion moves along the second moving direction, the original images, acquired by the image acquisition unit, are disposed along the second moving direction; and when the movable portion moves from the second moving direction to the first moving direction, the original images, acquired by the image acquisition unit, are reversely disposed along the second moving direction; and the image preprocessing unit splices the original images acquired by the image acquisition unit under the movement of the movable portion along the first moving direction;
wherein the image acquisition unit comprises an optical microscope, a charge coupled device is disposed on the optical microscope, the movable portion is the load-bearing platform of the optical microscope, and a shockproof mechanism is disposed on the load-bearing platform of the optical microscope.

15. The inspection apparatus for the display panel according to claim 2, wherein the image inspection unit inspects the image to be inspected in a preset direction and inspects a brightness value of the image to be inspected.

16. The inspection apparatus for the display panel according to claim 15, wherein the image inspection unit comprises an abnormal display region warning portion of the display panel, and when the image inspection unit inspects the brightness value of the image to be inspected enters a brightness value threshold of an abnormal display region, the abnormal display region warning portion outputs a result of issuing warning to the inspection apparatus.

17. The inspection apparatus for the display panel according to claim 2, wherein the image inspection unit inspects the image to be inspected in a preset direction and inspects a brightness value of the image to be inspected;
wherein the image inspection unit comprises the abnormal display region warning portion of the display panel; and when the image inspection unit inspects the brightness value of the image to be inspected enters the brightness value threshold of the abnormal display region, the abnormal display region warning portion outputs a result of issuing warning to the inspection apparatus.

18. An inspection method for a display panel, comprising the following steps:
acquiring original images by continually scanning the display panel by shooting the display panel;
preprocessing the acquired original images to obtain an image to be inspected; and inspecting the image to be inspected and outputting a result.

19. The inspection method for the display panel according to claim 18, wherein the step of acquiring original images by continually scanning the display panel by shooting the display panel comprises a step of transmitting the original images acquired within a preset range to a preprocessing step of the inspection method; and
the step of preprocessing the acquired original images to obtain the image to be inspected comprises a step of cutting and splicing the original images according to a preset size to obtain the image to be inspected.
